(19) United States
(12) Patent Application Publication
(10) Pub. No.: US 2008/0115634 A1
(43) Pub. Date: May 22, 2008

(54) Method and kit for repairing threads in a bore such as a spark plug hole

(76) Inventor: Charles Hampton, Stockbridge, GA (US)

Correspondence Address: WITHERS & KEYS, LLC, P. O. BOX 2049, MCDONOUGH, GA, 30253, US

(21) Appl. No.: 11/602,672

(22) Filed: Nov. 21, 2006

(51) Int. Cl. B25B 23/10

(52) U.S. Cl. 81/447

(57) ABSTRACT

Tools for cutting threads in a bore, such as a spark plug bore, are disclosed. Tools for inserting a threaded insert into threads of a bore, such as a spark plug bore, are disclosed. A kit containing a cutting tool, an insertion tool, optional threaded inserts, and an optional bonding material is disclosed. A method for cutting threads in a bore, such as a spark plug bore, is also disclosed.

### TECHNICAL FIELD

This disclosure relates to tools and methods for repairing threads in a bore, such as a spark plug hole of a combustion engine.

### BACKGROUND

The heart of the internal combustion engine is the cylinder and a key component in the cylinder operation is the spark plug. An internal combustion engine operates by creating a controlled explosion within the cylinder causing a piston in the cylinder to be forced in a downward direction as the gases from the explosion expand. The explosion is ignited by a spark from a spark plug at the top of the cylinder that extends partially into the cylinder. The spark plug is secured in place by threads cut into an opening in the cylinder head. Access to the spark plugs may be obtained through a bore in the cylinder head. The threads are strong enough to withstand peak explosive pressures and temperatures inside the cylinder that typically reach at least 200 pounds per square inch (psi) and 850° F. under normal running conditions.

It is not an uncommon occurrence, due to poor maintenance, manufacturing defect, and abnormal operation, that the threads cut into the spark plug bore catastrophically fail, causing the spark plug to be explosively dislodged from the spark plug bore and/or rendered inoperable. Typically, such a failure is repaired by removing the cylinder head and cutting new threads into the bottom portion of the spark plug bore immediately adjacent to the cylinder. A threaded insert with threads on inner and outer surfaces, or a coil of square wire, is permanently screwed into the newly cut threads in the spark plug hole resulting in a new set of inner threads able to accept the threads of a new spark plug and able to withstand the normal operating pressures inside the cylinder. One conventional process for repairing stripped threads within a spark plug bore is disclosed, for example, in U.S. Pat. No. 6,668,784.

Thread repair using conventional tools and methods, such as disclosed in U.S. Pat. No. 6,668,784, is time consuming and expensive because all engine components above the engine must be removed to gain access to the cylinder head and the spark plug hole. In addition, thread repair using conventional tools and methods, such as disclosed in U.S. Pat. No. 6,668,784, can result in damage to the engine due to improper placement of a threaded insert at a position too far into the cylinder (e.g., extending into and/or falling into the engine cylinder cavity).

There exists a need in the art for an efficient, inexpensive, and faster method of repairing threads within a bore, such as a spark plug bore, which allows precise repair of stripped spark plug holes without the time-consuming and inefficiencies of known methods. There also exists a need in the art for one or more tools that can be used to perform an efficient, inexpensive, and faster method of repairing threads within a bore, such as a spark plug bore, without potential damage to the engine.

### SUMMARY

The present invention is directed to tools suitable for repairing threads within a bore, such as a spark plug bore of a combustion engine. Tools of the present invention include a cutting or threading tool capable of providing new threads within a bore, and an insertion tool capable of positioning a threaded insert into the new threads of the bore. The tools of the present invention may be used in combination with one or more threaded inserts that are capable of engaging with new threads of the bore, formed by the cutting or threading tool, so as to house a threaded object, such as a spark plug.

One aspect of the present invention is directed to a cutting or threading tool for creating threads within a bore. In one exemplary embodiment, the cutting or threading tool comprises a self-centering shaft member comprising a first end, a second end, and an outermost periphery that allows the threading tool to be inserted freely into the bore with minimal interstitial space between at least a portion of the outermost periphery of the shaft member and an inner surface of the bore; a cutting element integrally connected to the first end and centrally located along a dissecting axis of said shaft member, said cutting element being operatively adapted to create threads within a portion of the bore; and a coupling component proximate the second end, said coupling component being operatively adapted to connect to a mechanical power source capable of rotating said shaft member.

Another aspect of the present invention is directed to an insertion tool operatively adapted to insert a threaded insert into threads formed by the threading tool. In one exemplary embodiment, the insertion tool comprises a self-centering insertion tool shaft member comprising an insertion tool first end, an insertion tool second end, and an insertion tool outermost periphery that allows the insertion tool to be inserted freely into the bore with minimal interstitial space between at least a portion of the insertion tool outermost periphery of the insertion tool shaft member and the inner surface of the bore; an externally threaded element integrally connected to the insertion tool first end and centrally located along a dissecting axis of said insertion tool shaft member, said externally threaded element being operatively adapted to engage with a threaded insert; and an insertion tool coupling component proximate the insertion tool second end, said insertion tool coupling component being operatively adapted to connect to a mechanical power source capable of rotating said insertion tool shaft member.

The present invention is further directed to a kit for repairing threads within a bore. In one exemplary embodiment, the kit comprises (1) a threading tool operatively adapted to create threads within a bore, wherein the threading tool comprises a self-centering threading tool shaft member comprising a first end, a second end, and an outermost periphery that allows the threading tool to be inserted freely into the bore with minimal interstitial space between at least a portion of the outermost periphery of the threading tool shaft member and an inner surface of the bore; a cutting element integrally connected to the first end and centrally located along a dissecting axis of said threading tool shaft member, the cutting element being operatively adapted to create threads within a portion of the bore; and a threading tool coupling component proximate the second end, the threading tool coupling component being operatively adapted to connect to a mechanical power source capable of rotating the threading tool shaft member; and (2) an insertion tool operatively adapted to insert a threaded insert into threads formed by the threading tool, wherein the insertion tool comprises a self-centering insertion tool shaft member comprising an insertion tool first end, an insertion tool second end, and an insertion tool outermost periphery that allows the insertion tool to be inserted freely into the bore with minimal interstitial space between at least a portion of the insertion tool outermost periphery of the insertion tool shaft member and the inner surface of the bore; an externally threaded element integrally connected to the insertion tool first end and centrally located along a dissecting axis of said insertion tool shaft member, the externally threaded element having a threaded element diameter that is less than a largest diameter of the cutting element and being operatively adapted to engage with a threaded insert; and an insertion tool coupling component proximate the insertion tool second end, the insertion tool coupling component being operatively adapted to connect to a mechanical power source capable of rotating the insertion tool shaft member. The kit may further comprise (i) one or more threaded inserts having an inner diameter substantially equal to the threaded element diameter of the insertion tool and an outer diameter substantially equal to a largest diameter of the cutting element of the threading tool; and (ii) a bonding agent for bonding a threaded insert with threads formed by the threading tool.

The present invention is even further directed to a method for repairing a spark plug hole within a cylinder head of an internal combustion engine. In one exemplary embodiment, a method for repairing a spark plug hole within a cylinder head of an internal combustion engine comprises inserting a self-centering threading tool into a spark plug bore having the spark plug hole therein; rotating the threading tool until the threading tool stops within the spark plug bore indicating that a new set of threads has been cut into the spark plug hole; and removing the threading tool. The exemplary method may further comprise removably mounting a threaded insert onto a distal end of a self-centering insertion tool; inserting the self-centering insertion tool into the spark plug bore so that the distal end and threaded insert are proximate the newly threaded spark plug hole; rotating the insertion tool until the insertion tool stops within the bore so as to engage the threaded insert with the new set of threads cut into the spark plug hole; and removing the insertion tool.

Other features and advantages of the invention will be apparent from the following drawings, detailed description, and claims.

### BRIEF DESCRIPTION OF DRAWINGS

FIG. 1 is a cut away view of a cylinder head depicting a spark plug bore and spark plug of the prior art;

FIG. 2 is a cross section of an exemplary cutting tool of the present invention;

FIG. 3 is a cross section of an exemplary insertion tool of the present invention;

FIGS. 4A-C show exemplary thread inserts suitable for use with the exemplary insertion tool of FIG. 3;

FIGS. 5A-B provides a flow chart showing steps in an exemplary method of repairing stripped threads within a spark plug bore using the tools of the present invention;

FIG. 6 depicts a cut away view of a spark plug bore having stripped threads and the exemplary cutting tool of FIG. 2 positioned therein (prior to repair);

FIG. 7 depicts a cut away view of a spark plug bore having stripped threads and the exemplary cutting tool of FIG. 2 shown during a repair step;

FIG. 8 depicts a cut away view of a spark plug bore having new threads, an exemplary insert for connecting with the new threads, and the exemplary insertion tool of FIG. 3 shown prior to an insert insertion step; and

FIG. 9 is a cut away view of an exemplary repaired cylinder head with a thread insert and spark plug positioned therein.

### DETAILED DESCRIPTION

The following detailed description is directed to tools, a kit comprises the tools, and a method for repairing damaged threads within a bore, such as a spark plug hole. In the following detailed description, references are made to the accompanying drawings that form a part hereof and which are shown, by way of illustration, using specific embodiments or examples. Referring now to the drawings, in which like numerals represent like elements through the several figures, aspects of the tools and methods provided herein will be described.

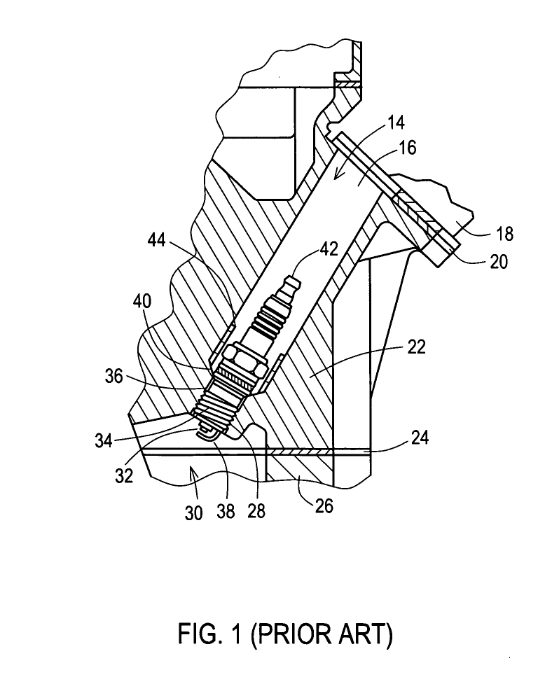

FIG. 1 depicts a cut away view of a conventional cylinder head 22 and a spark plug bore 14 therein. Cylinder head 22 is mounted on engine block 26 with head gasket 24 therebetween. Exhaust manifold 18 is attached to the top of the cylinder head 22 with manifold gasket 20 creating a seal therebetween. Spark plug 42 resides in spark plug bore 14. Spark plug bore 14 has an upper tube section 16 and a lower thread section 28 that creates an opening 32 (i.e. a spark plug hole) into cylinder 30 allowing a lower portion 38 of spark plug 42 to extend into cylinder 30. Depending on the length of lower threaded portion 28, there may also be an intermediate unthreaded portion 36 extending parallel with lower thread section 28. A collar 40 separates upper tube section 16 from lower thread section 28. Spark plug 42 includes a threaded portion 34 that engages with threads along lower threaded section 28.

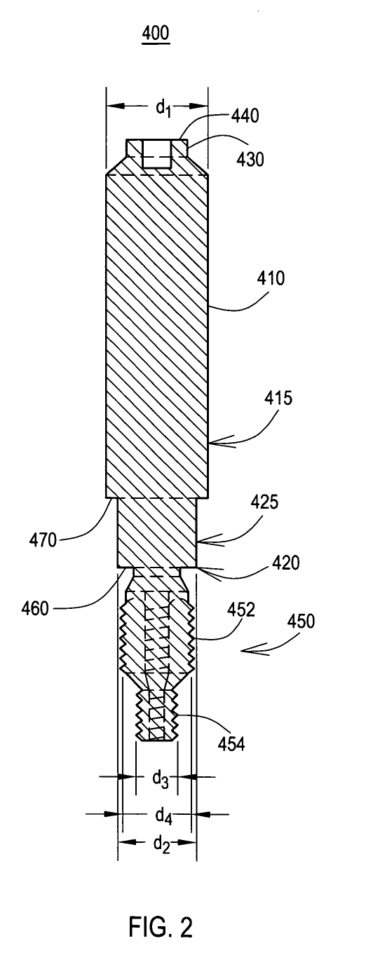

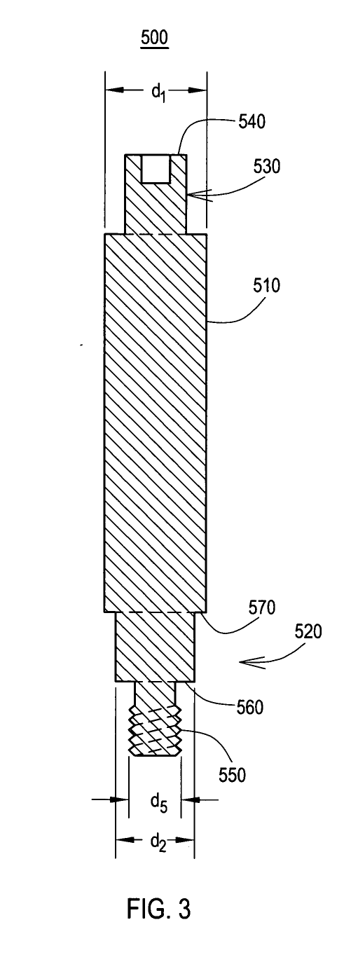

The present invention provides tools suitable for repairing threads within a bore, such as threads within lower thread section 28 of spark plug bore 14 shown in FIG. 1. The present invention also provides an insertion tool capable of positioning a threaded insert into the new threads of the bore, such as new threads within lower thread section 28 of spark plug bore 14. An exemplary cutting or threading tool of the present invention is shown in FIG. 2, while an exemplary insertion tool of the present invention is shown in FIG. 3.

FIG. 2 provides a cross sectional diagram of an exemplary cutting or threading tool 400 of the present invention. Exemplary cutting tool 400 includes a shaft 410 with a first end 420 and a second end 430. Second end 430 comprises a coupling component 440 operatively adapted to receive a tool or be received by a tool so as to rotate shaft 410. In one exemplary embodiment, coupling component 440 is constructed to receive a connection from a ratchet wrench or some other source of torque with which to rotate shaft 410 about its axis (i.e., coupling component 440 represents a female connection). In another exemplary embodiment, coupling component 440 is constructed to be received by a wrench or other tool capable of providing torque with which to rotate shaft 410 (i.e., coupling component 440 represents a male connection). Suitable tools for providing torque to shaft 410 may include, but are not limited to, a ratchet wrench, a wrench, an electric drill, an air ratchet, etc.

As shown in FIG. 2, exemplary cutting tool 400 of the present invention desirably comprises an upper shaft portion 415 having a first diameter d₁ and a lower shaft portion 425 extending from first end 420 to upper shaft portion 415, wherein lower shaft portion 425 has a second diameter d₂ that is less than first diameter d₁ so as to provide a first shoulder 470 extending along an outer periphery of shaft member 410 at an intersection between upper shaft portion 415 and lower shaft portion 425. The leading edge of first shoulder 470 may be perpendicular to shaft 410 or may be otherwise shaped to complement a second collar 44 within spark plug bore 14 (see, for example, second collar 44 shown in FIG. 1). In some embodiments of the present invention, the purpose of first shoulder 470 is to engage with second collar 44, when present, and limit (i.e., stop) the movement of cutting tool 400 longitudinally into spark plug bore 14 while cutting new threads. In other embodiments of the present invention, first shoulder 470 is merely present so as (i) to provide a shaft portion that helps center cutting tool 400 (e.g., shaft portion 415) within the bore and (ii) to allow a lower shaft portion having a smaller shaft diameter to freely extend into the bore a desired distance when a collar (e.g., second collar 44) or other obstruction is within the bore so that second shoulder 460 (described below) may be used to limit (i.e., stop) the movement of cutting tool 400 longitudinally into spark plug bore 14 while cutting new threads.

Exemplary cutting tool 400 may further comprise a second shoulder 460 circumscribing shaft 410 at first end 420. Second shoulder 460 may be in addition to or in place of first shoulder 470. The leading edge of second shoulder 460 may be perpendicular to shaft 410 or may be otherwise shaped to complement collar 40 within spark plug bore 14 (see, for example, collar 40 shown in FIG. 1). The purpose of second shoulder 460, when present, is to engage with collar 40 and limit (i.e., stop) the movement of cutting tool 400 longitudinally into spark plug bore 14 while cutting new threads.

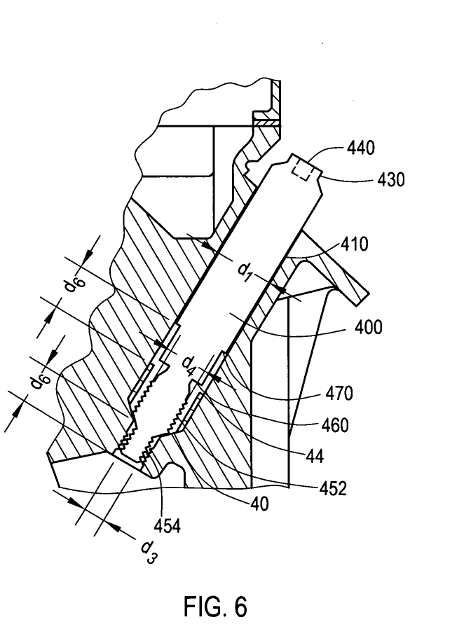

At least a portion of shaft 410 has a diameter d₁ of such a size so as to result in minimal interstitial space between at least a portion of the outermost periphery of shaft 410 of cutting tool 400 and an inner surface of the bore (i.e., diameter d₁ of shaft 410 is slightly less than a diameter of spark plug bore 14). As a result of the outermost dimensions of shaft 410, cutting tool 400 is self-centering within spark plug bore 14. As a result, cutting element 450 of cutting tool 400 is simultaneously centered in narrow threaded portion 28 (i.e. the spark plug hole) of spark plug bore 14 when inserted therein (see, for example, FIG. 6).

The diameter of shaft 410 is also of such a diameter as to allow cutting tool 400 to turn within a bore (e.g., spark plug bore 14) without binding. As a non-limiting example, Ford 4.6 liter and 5.4 liter engines, Mitsubishi 3.0 liter engines, and Toyota 22R engines have a spark plug bore with an inside diameter of about 0.940 inches. In such a case, at least a portion of shaft 410 will have an outside diameter d₁ of about 0.935 inches so as to leave sufficient interstitial space to prevent binding and simultaneously center shaft 410 and cutting element 450 within spark plug bore 14. It should be recognized that there are a variety of different cylinder heads and spark plug bores for different engine types. The diameters chosen for shaft 410 will vary to match the dimensions of different cylinder heads and spark plug bores therein.

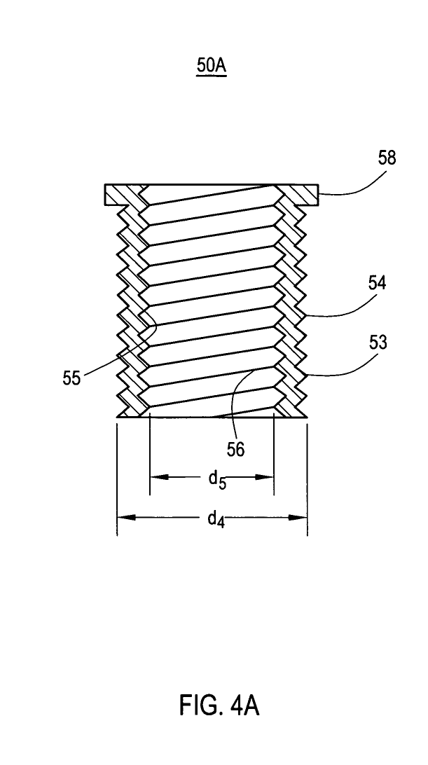

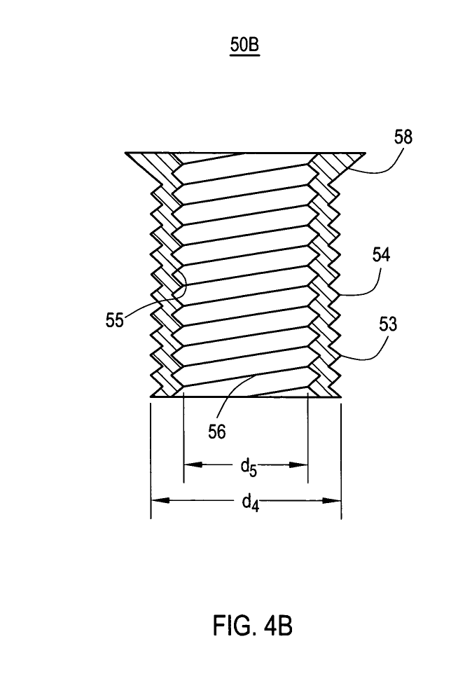

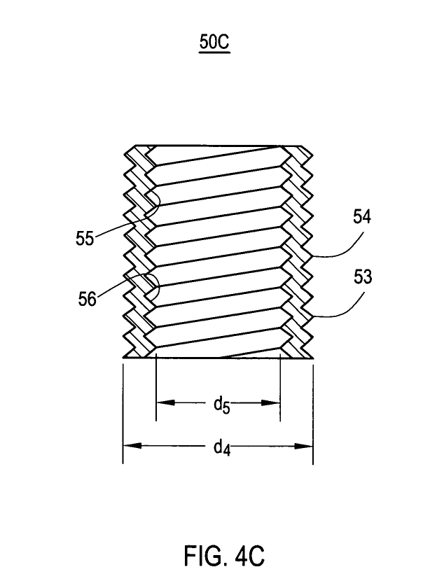

Exemplary cutting tool 400 also comprises cutting element 450, which may be, and is desirably, integrally and permanently attached to shaft 410 at first end 420. Alternatively, cutting element 450 may be detachably secured and interchangeable with other similar cutting elements 450 having varying dimensions to match various bore dimensions (e.g., to match the dimensions of different cylinder heads and spark plug bores therein). Cutting element 450 extends longitudinally and concentrically from narrowed first end 420 of shaft 410. Cutting element 450 as depicted herein may include a wide threaded portion 452 of diameter d₄ and a narrow threaded portion 454 of diameter d₃. Wide threaded portion 452 is adjacent to second shoulder 460 and may be of such a diameter so as to cut new threads having diameter d₄ that match an outer diameter of a threaded insert to be inserted into spark plug hole 32 (see, for example, exemplary threaded inserts 50 having outer diameter d₄ and outer threads 54 in FIGS. 4A-C). The new threads may be of such a diameter as to accept threaded insert 50 (see FIG. 4A-C). Narrow threaded portion 454 is located on the distal end of cutting element 450 and may be of a narrower diameter d₃ that substantially matches a bore diameter (e.g., a spark plug hole diameter) prior to a re-threading step (e.g., matches the diameter of lower threaded portion 28 shown in FIG. 1). In such an embodiment, narrow threaded portion 454 assists in centering exemplary cutting tool 400 within a bore.

In an alternative embodiment (not shown), exemplary cutting tool 400 may comprise a single threaded portion (e.g., wide threaded portion 452) having a tapered end so that an end portion of the tapered end extends into a bore (e.g., a spark plug hole) prior to a re-threading step, and assist in centering cutting tool 400 within the bore.

Exemplary cutting tool 400 may have dimensions that vary depending on the end use of exemplary cutting tool 400. When used to re-thread stripped threads within a spark plug bore, exemplary cutting tool 400 typically has an overall length of from about 4.0 inches (in) to about 9.0 in, more typically, from about 5.5 in to about 8.0 in; an outermost periphery having a largest diameter of from about 0.8 in to about 1.2 in, and a threaded cutting member with a length of from about 0.5 in to about 2.0 in, more typically, from about 1.0 in to about 1.5 in. The length of shaft 410 in FIG. 2, although not to scale, is typically about 6 in, but may be any desired length sufficient to allow an appropriate source of torque to be applied from an upper section of a bore (e.g., spark plug bore 14) or from outside the bore (e.g., spark plug bore 14). Typically, the cutting tool of the present invention has a length such that an upper portion of the cutting tool (e.g., second end 430 and coupling component 440 of exemplary cutting tool 400) is positioned within an upper section of a bore (e.g., spark plug bore 14) or slightly outside the bore (e.g., spark plug bore 14) so that a tool (e.g., a wrench or wrench coupling) can be used to rotate the cutting tool.

It should be further noted that the above-described cutting tool 400 may be used in other application for cutting threads other than for spark plug bores and that applications other than re-threading of spark plug bores is fully contemplated herein.

FIG. 3 is a plane view diagram of an exemplary insertion tool 500 of the present invention. Exemplary insertion tool 500 comprises an insertion tool shaft 510, an insertion tool first end 530, an insertion tool second end 560, and an externally threaded element 550. First end 560 may comprise an attachment point 540 constructed to receive a connection from a ratchet wrench or some other source of torque (or be received by a wrench or some other source of torque) with which to rotate shaft 510 about its axis. The tool or other power source used to rotate exemplary insertion tool 500 may be any device operatively adapted to rotate shaft 510 about its axis, such as those described above as being suitable for rotating exemplary cutting tool 400.

Exemplary insertion tool 500 comprises a first insertion tool shoulder 560 extending along an outer periphery of insertion tool 500 at an intersection between shaft 510 and externally threaded element 550, wherein first insertion tool shoulder 560 is operatively adapted to engage with a collar within a bore (see, for example, collar 40 in FIG. 1) so as to stop insertion tool 500 during a threaded insert insertion step. In some embodiments, exemplary insertion tool 500 comprises a second insertion tool shoulder 570 extending along an outer periphery of insertion tool 500 at an intersection between an upper insertion tool shaft portion 515 and a lower insertion tool shaft portion 520, wherein second insertion tool shoulder 560 is operatively adapted to engage with a collar, when present, within the bore (see, collar 44 in FIG. 1) so as to stop insertion tool 500 during a threaded insert insertion step. In other embodiments, such as shown in FIG. 3, exemplary insertion tool 500 comprises first insertion tool shoulder 560 and second insertion tool shoulder 570. When first insertion tool shoulder 560 and second insertion tool shoulder 570 are both present, first insertion tool shoulder 560 is typically utilized to stop insertion tool 500 during a threaded insert insertion step, while second insertion tool shoulder 570 is merely present so as (i) to provide a shaft portion (e.g., shaft portion 510) that helps center insertion tool 500 within the bore and (ii) to allow a lower shaft portion (e.g., shaft portion 520) having a smaller shaft diameter to freely extend into the bore a desired distance when a collar (e.g., second collar 44) or other obstruction is within the bore so that first insertion tool shoulder 560 may be used to limit (i.e., stop) the movement of exemplary insertion tool 500 longitudinally into spark plug bore 14.

Externally threaded element 550 of exemplary insertion tool 500 may extend longitudinally and concentrically from second end 560. Threaded element 550 with outside diameter d₅ may be threaded to accept the inner threads of a threaded insert with internal diameter d₅ (see, for example, threaded inserts 50 in FIGS. 4A-C having inside diameter d₅ and inner threads 56). In some embodiments, outside diameter d₅ of threaded element 550 is substantially equal to (i) diameter d₃ of narrow threaded portion 454 (see, FIG. 2) and (ii) a bore diameter (e.g., a spark plug hole diameter) prior to a re-threading step (i.e., the diameter of lower threaded portion 28 shown in FIG. 1 prior to a re-threading step, namely, the diameter of threaded portion 34 of spark plug 42).

As discussed above, lower insertion tool shaft portion 520 may include first insertion tool shoulder 560 at its distal end and adjacent to externally threaded element 550. First insertion tool shoulder 560 may be at right angles to the axis of shaft 510 and is operatively adapted to engage with collar 40 within spark plug bore 14 as shown in FIG. 1. First shoulder 560 may also be formed to have an angular relationship to the axis of the shaft 510 other that perpendicular and may be formed to complement an alternative construction of collar 40 (e.g., a corresponding angular construction). As discussed above, first shoulder 560 may be used to prevent insertion tool 500 from inserting a threaded insert into cylinder 30 by engaging with collar 40 inside spark plug bore 14.

As discussed above, exemplary insertion tool 500 may also include second shoulder 570. Second shoulder 570 may accommodate a second collar 44 within the spark plug bore, when present, thereby preventing insertion tool 500 from inserting a threaded insert into cylinder 30 by engaging with collar 44 inside the spark plug bore 14.

At least a portion of shaft 510 has a diameter d₁ of such a size so as to result in minimal interstitial space between at least a portion of the outermost periphery of shaft 510 of insertion tool 500 and an inner surface of the bore (i.e., diameter d₁ of shaft 510 is slightly less than a diameter of spark plug bore 14). As a result of the outermost dimensions of shaft 510, insertion tool 500 is self-centering within spark plug bore 14. As a result, externally threaded element 550 of insertion tool 500 is simultaneously centered so as to engage with new threads cut into narrow threaded portion 28 (i.e. the spark plug hole) of spark plug bore 14 (see, FIG. 1).

As discussed above with regard to diameter d₁ of shaft 410 of exemplary cutting tool 400, diameter d₁ of at least a portion of shaft 510 is of such a diameter so as to allow shaft 510 to turn without binding. As a non-limiting example, if spark plug bore 14 has an inside diameter of about 0.940 in, shaft 510 will have an outside diameter of about 0.935 in so as to prevent binding. As discussed above, since there is a variety of different cylinder heads and spark plug bores for different engine types, insertion tools of the present invention will have a variety of outermost diameters for shaft 510 so as to match the dimensions of different cylinder heads and spark plug bores therein.

Further, as discussed above with regard to the cutting tools of the present invention, it should be noted that the above-described insertion tool may be used in other application for inserting threaded inserts other than for spark plug bores and that applications other than repairing threads of spark plug bores is fully contemplated herein.

Insertion tools of the present invention will have overall dimensions similar to those described above with regard to the cutting tool. When used to insert a threaded insert into new threads within a spark plug bore, exemplary insertion tool 500 typically has an overall length of from about 4.0 inches (in) to about 9.0 in, more typically, from about 5.5 in to about 8.0 in; an outermost periphery having a largest diameter of from about 0.8 in to about 1.2 in, and a threaded cutting member with a length of from about 0.5 in to about 2.0 in, more typically, from about 1.0 in to about 1.5 in. The length of shaft 510 in FIG. 3, although not to scale, is typically about 6 in, but may be any desired length sufficient to allow an appropriate source of torque to be applied from an upper section of a bore (e.g., spark plug bore 14) or from outside the bore (e.g., spark plug bore 14). Typically, the insertion tool of the present invention has a length such that an upper portion of the insertion tool (e.g., first end 530 and coupling component 540 of exemplary insertion tool 500) is positioned within an upper section of a bore (e.g., spark plug bore 14) or slightly outside the bore (e.g., spark plug bore 14) so that a tool (e.g., a wrench or wrench coupling) can be used to rotate the insertion tool.

The present invention further comprises a kit comprising the above-described cutting tool in combination with the above-described insertion tool. Such a kit may optionally further comprise one or more threaded inserts such as exemplary threaded inserts 50A-C shown in FIGS. 4A, 4B and 4C. FIGS. 4A, 4B and 4C show cross-sectional views of exemplary threaded inserts 50A-C that may be used to replace damaged threads within a bore, such as spark plug hole 32. FIG. 4A depicts threaded insert 50A with outer threads 53 cut into an outer surface 54, inner threads 55 cut into an inner surface 56, and a lip 58. Outer threads 53 are capable of engaging with newly cut threads formed by the above-described cutting tool (i.e., exemplary cutting tool 400) within spark plug hole 32 (see, for example, spark plug hole 32 shown in FIG. 1). Inner threads 55 are capable of engaging with a threaded portion of a spark plug (see, for example, threaded portion 34 of spark plug 42 shown in FIG. 1). Lip 58 may engage collar 40 within spark plug bore 14 to ensure a proper insertion depth. Lip 58 may also be tapered as shown in FIG. 4B.

FIG. 4C depicts a cross-sectional view of another exemplary threaded insert 50 with outer threads 53 cut into outer surface 54 and inner threads 55 cut into inner surface 56; however, exemplary threaded insert 50C does not comprise a lip. Outer threads are capable of engaging with newly cut threads 53 in spark plug hole 32. Inner threads 56 are capable of engaging with spark plug threads 34. Exemplary threaded inserts 50A-C may be fixed in place with a bonding compound (e.g., a thermosettable adhesive such as an epoxy-containing adhesive). The setting compound may be of any suitable compound known in the art. Non-limiting examples may be a two part epoxy, J-B Quick Weld™ or Lock Tight™. The bonding compound may be an optional component in a kit comprising the cutting tool, the insertion tool, and one or more of the threaded inserts.

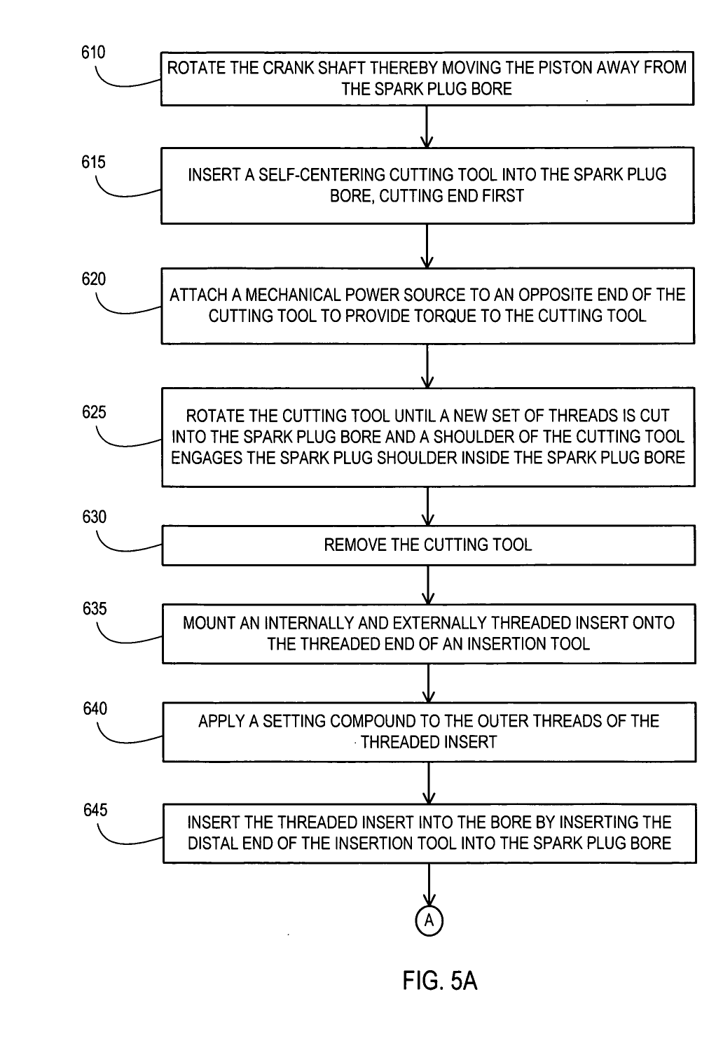

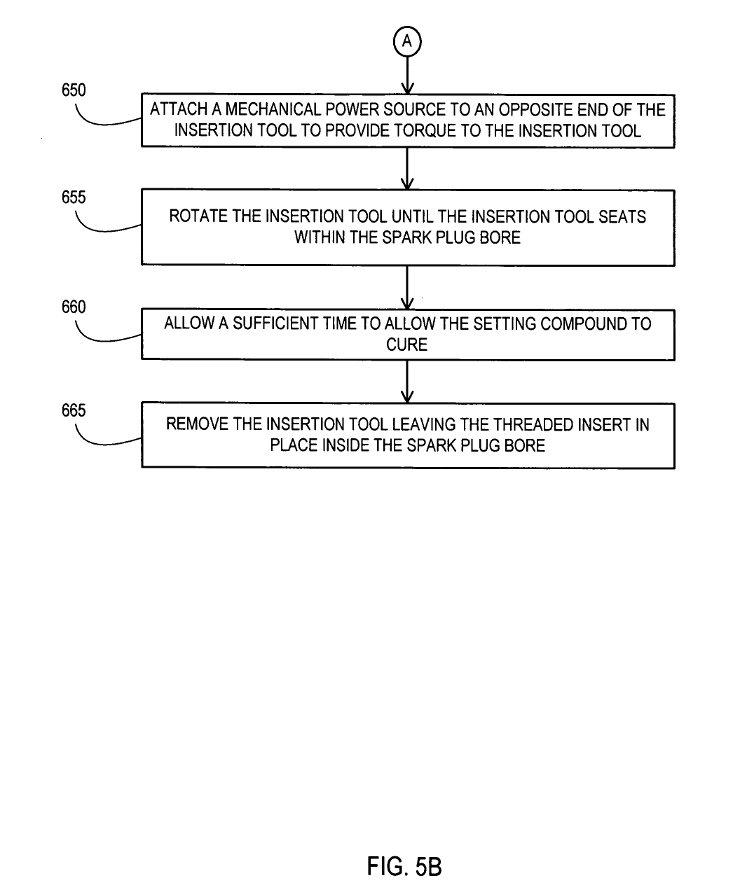

Exemplary tools 400 and 500 enable a relatively easy method to repair lower threaded section of spark plug hole 32 without removing the cylinder head. FIGS. 5A-B provide a flow chart showing exemplary steps for repairing stripped threads of a spark plug hole using the above-described tools of the present invention. The repair method utilizes cutting tool 400 to cut new threads within spark plug hole 32. To the extent that the spark plug is obstructing the spark plug bore 14, the spark plug should first be removed. Further as a precaution, in order to prevent damage to the piston, the crank shaft of the engine is desirably rotated to move the piston, in the cylinder to be worked on, away from spark plug hole 32 at process step 610 as shown in FIG. 5A.

After gaining access to upper portion 16 of spark plug bore 14 and typically without removing the cylinder head 30, first end 420 of cutting tool 400 is inserted into spark plug bore 14 at process step 615. As cutting tool 400 is inserted, cutting element 450 is automatically centered in spark plug bore 14 by shaft 410 since the space between an outer surface of shaft 410 and an inner surface of spark plug bore 14 is minimal. Narrow threaded portion 454 on the distal end of cutting element 454 is centered in spark plug hole 32 when cutting tool 400 is fully inserted. At process step 620, a source of mechanical power is attached to attachment point 440 so as to provide torque to shaft 410. At process step 625, cutting tool 400 is rotated by the mechanical power source so as to cut new threads spiraling downward into spark plug hole 32. When second shoulder 460 (or first shoulder 470) of cutting tool 400 engages collar 40 (or collar 44) within spark plug bore 14, the downward motion of cutting tool 400 stops and the new threads have been completed. Cutting tool 400 is removed at process step 630 by reversing the rotation on cutting tool 400 and backing cutting tool 400 out of the new threads. Any retrograde materials remaining in the chamber 30 may be removed with a vacuum line or a magnet if necessary.

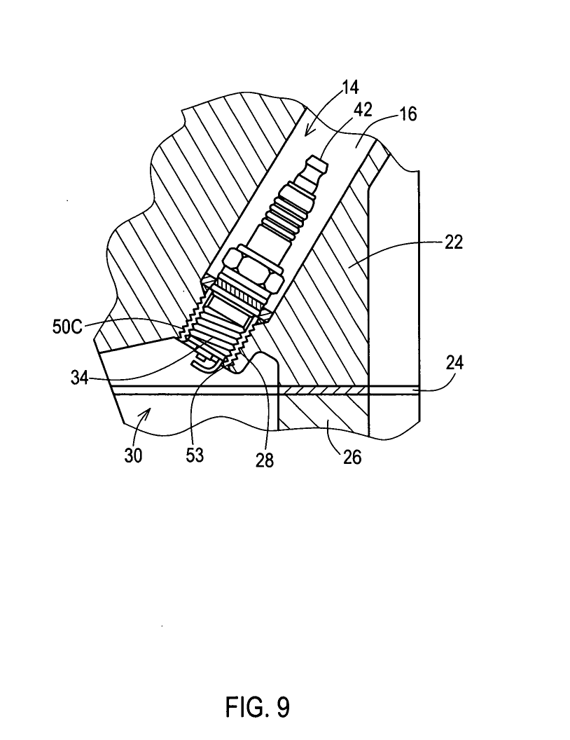

At process step 635, a threaded insert (e.g., threaded insert 50C) (or a coiled wire) is mounted onto threaded element 550 of insertion tool 500 by screwing insert 50C (or wrapping a coiled wire) onto threaded element 550 where inner threads 55 of threaded insert 50C engage with threaded element 550, both of which have a diameter d₅ Threaded insert 50C may be of any length desired but its outer diameter d₄ is such that outer threads 53 on outer surface 54 of threaded insert 50C engage with the newly cut threads in spark plug bore 14 and inner threads 55 on inner surface 56 securely engage with threads on a replacement spark plug (see FIG. 9). To ensure that threaded insert 50C is permanently affixed in the spark plug hole 32, a setting/bonding compound may be applied to outer threads 54 in process step 640 before insertion.

At process step 645, second end 560 of insertion tool 500 with threaded insert 50C is inserted into spark plug bore 14. Because the outside diameter of shaft 510 is a flush fit with the inside surface of spark plug bore 14, insertion tool 500 automatically aligns (i.e., centers) itself with the spark plug hole 32 and the newly cut threads therein. Once inserted, a mechanical power source may be attached to attachment point 540 of insertion tool 500 at process step 650 as shown in FIG. 5B. As discussed above, the mechanical power source may be any mechanical attachment device including, but not limited to, a manually operated wrench, an electric motor, an air ratchet, a torque wrench or a hydraulic motor.

Once inserted, insertion tool 500 is rotated until first shoulder 560 engages collar 40 (or second shoulder 570 engages collar 44) inside spark plug bore 14 at process step 655. When the downward motion of insertion tool 500 is stopped by collar 40 (or collar 44), threaded insert 50C is fully inserted. If a setting compound is used, sufficient time may be allowed to allow the compound to cure at process step 660. Following any cure period, insertion tool 500 is removed by reversing its direction of rotation at process step 665.

As discussed above, a kit of components suitable for executing the above-described method may include a cutting tool such as exemplary cutting tool 400, and an insertion tool such as insertion tool 500. One or more threaded inserts (e.g., exemplary threaded inserts 50A-C), and a setting/bonding compound may be optional components of the kit. Cutting and insertion tools with tools shafts 410/510 of various size diameters may be included in a kit so as to be able to perform repairs on different motor designs. Similarly, there may be tool shafts 410/510 with various detachable cutting elements 450 and threaded elements 550 having varying dimensions so as to perform repairs on different motor designs.

FIG. 6 is an illustration of an exemplary self-centering cutting tool 400 inserted into spark plug bore 14 and prior to cutting a new set of threads 28. Because diameter d₁ of cutting tool shaft 410 is approximately the same diameter of the bore and cutting element 450 is coaxially connected, cutting tool 400 self-aligns cutting portion 450 in spark plug bore 14. In this exemplary depiction, narrow threaded portion 454 with diameter d₃ is narrower than spark plug hole 28. Even though narrow threaded portion 454 does not engage the periphery of spark plug hole 28 in this exemplary embodiment, narrow threaded portion 454 assists in aligning cutting tool 400 in spark plug hole 28. As shown in FIG. 6, wide threaded portion 452 engages collar 40 of bore 14 in preparation for cutting a new set of threads into spark plug hole 28. As shaft 410 is rotated, in this exemplary embodiment, wide threaded portion 452 of cutting element 450 cuts new threads, and cutting tool 400 advances a distance d₆ or until shoulder 460 contacts collar 40.

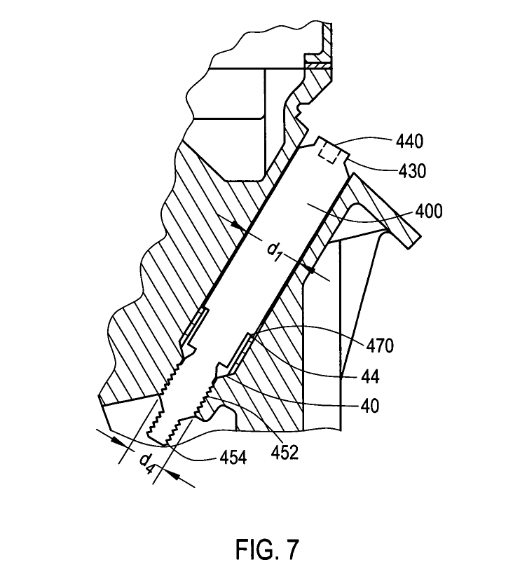

FIG. 7 is an illustration of exemplary self-centering cutting tool 400 after having been rotated and after cutting a new set of threads into spark plug hole 28. Spark plug hole 32 now has a diameter of d₄, which corresponds to diameter d₄ of wide threaded portion 452. In this embodiment, first shoulder 470 engages with collar 44 thus stopping further motion of cutting tool 400; however, it should be understood that in other embodiments, second shoulder 460 may engage with collar 40 within bore 14 so as to stop further motion of cutting tool 400 into bore 14. As discussed above, some spark plug bores may not have a collar 44 to be engaged by first shoulder 470, and in such a case, second shoulder 460 engages with collar 40 within bore 14 so as to stop further motion of cutting tool 400 into bore 14. However, the lack of collar 44 within bore 14 does not affect the operation of cutting tool 400 due to the presence of collar 40 within bore 14.

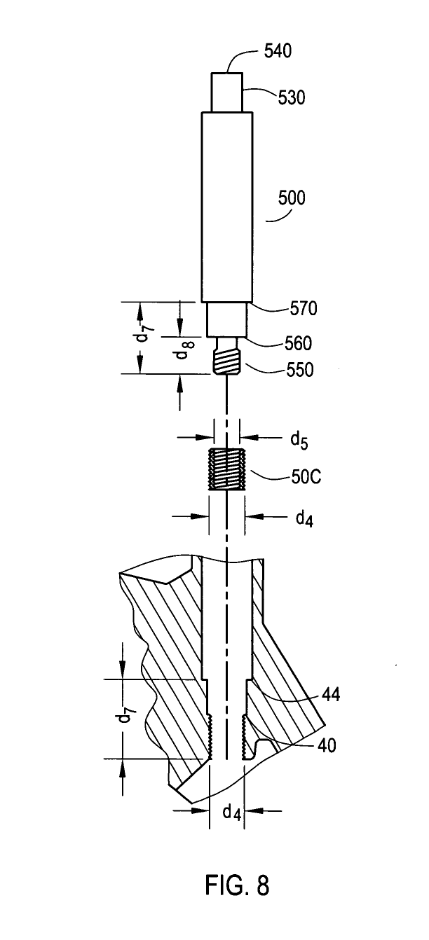

FIG. 8 is an illustration depicting exemplary self-centering insertion tool 500 prior to being inserted into bore 14. Threaded insert 50C with inner diameter d₅ and outer diameter d₄ is threaded onto threaded element 550 with an outside diameter of d₅. Inner threads 55 of thread insert 50C are of a size so as to engage with outer threads of threaded element 550. Outer threads 53 of threaded element 550 are of a size so as to engage the newly cut threads of spark plug hole 28 with a diameter of d₄.

The distance d₇ is the distance from first shoulder 570 of insertion tool 500 to the distal end of the threaded element 550. The distance d₈ is also the distance from collar 44 in bore 14 to the combustion chamber 30. Distance d₇ may be prescribed by the make and model of the engine being repaired as excessive intrusion of the threaded insert 50C may interfere with spark plug operation. Distance d₈ from the first shoulder 560 to the distal end of threaded element 550 may be of any length sufficient to secure threaded insert 50C to threaded element 550 and to position threaded insert 50C at a desired location within the new threads in spark plug hole 32.

FIG. 9 is an exemplary depiction of a spark plug 42 seated in threaded insert 50C, after the repair method described has been completed. As depicted, threaded insert 50C does not extend into combustion chamber 30.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A kit for repairing threads within a bore comprising:
(i) a threading tool operatively adapted to create threads within the bore, said threading tool comprising:
a self-centering threading tool shaft member including a first end, a second end, and an outermost periphery that allows the threading tool to be inserted freely into the bore with minimal interstitial space between at least a portion of the outermost periphery of the threading tool shaft member and an inner surface of the bore;
a cutting element integrally connected to the first end and centrally located along a dissecting axis of said threading tool shaft member, said cutting element being operatively adapted to create threads within a portion of the bore; and
a threading tool coupling component proximate the second end, said threading tool coupling component being operatively adapted to connect to a mechanical power source capable of rotating said threading tool shaft member; and
(ii) an insertion tool operatively adapted to insert a threaded insert into threads formed by said threading tool, wherein said insertion tool comprises:
a self-centering insertion tool shaft member including an insertion tool first end, an insertion tool second end, and an insertion tool outermost periphery that allows the insertion tool to be inserted freely into the bore with minimal interstitial space between at least a portion of the insertion tool outermost periphery of the insertion tool shaft member and the inner surface of the bore;
an externally threaded element integrally connected to the insertion tool first end and centrally located along a dissecting axis of said insertion tool shaft member, said externally threaded element having a threaded element diameter that is less than a largest diameter of said cutting element and being operatively adapted to engage with a threaded insert; and
an insertion tool coupling component proximate the insertion tool second end, said insertion tool coupling component being operatively adapted to connect to a mechanical power source capable of rotating said insertion tool shaft member.

2. The kit of claim 1, wherein said threading tool comprises (i) a first threading tool shoulder extending along an outer periphery of the threading tool at an intersection between said threading tool shaft member and said cutting element, said first threading tool shoulder being operatively adapted to engage with a collar within the bore so as to stop said threading tool during a threading step, (ii) a second threading tool shoulder extending along an outer periphery of the threading tool shaft member at an intersection between an upper threading tool shaft portion and a lower threading tool shaft portion, said second threading tool shoulder being operatively adapted to engage with a collar within the bore so as to stop said threading tool during a threading step, or (iii) both (i) and (ii).

3. The kit of claim 2, wherein said insertion tool comprises (i) a first insertion tool shoulder extending along an outer periphery of the insertion tool at an intersection between said insertion tool shaft member and said externally threaded element, said first insertion tool shoulder being operatively adapted to engage with a collar within the bore so as to stop said insertion tool during a threaded insert insertion step, (ii) a second insertion tool shoulder extending along an outer periphery of the insertion tool shaft member at an intersection between an upper insertion tool shaft portion and a lower insertion tool shaft portion, said second insertion tool shoulder being operatively adapted to engage with a collar within the bore so as to stop said insertion tool during a threaded insert insertion step, or (iii) both (i) and (ii).

4. The kit of claim 1, wherein said insertion tool comprises (i) a first insertion tool shoulder extending along an outer periphery of the insertion tool at an intersection between said insertion tool shaft member and said externally threaded element, said first insertion tool shoulder being operatively adapted to engage with a collar within the bore so as to stop said insertion tool during a threaded insert insertion step, (ii) a second insertion tool shoulder extending along an outer periphery of the insertion tool shaft member at an intersection between an upper insertion tool shaft portion and a lower insertion tool shaft portion, said second insertion tool shoulder being operatively adapted to engage with a collar within the bore so as to stop said insertion tool during a threaded insert insertion step, or (iii) both (i) and (ii).

5. The kit of claim 1, further comprising one or more threaded inserts having an inner diameter substantially equal to said threaded element diameter of said insertion tool and an outer diameter substantially equal to said largest diameter of said cutting element.

6. The kit of claim 1, further comprising a bonding agent for bonding a threaded insert with threads formed by said threading tool.

7. A method of repairing stripped threads within a spark plug bore of an engine cylinder head, said method comprising:
creating new threads within the spark plug bore; and
inserting a threaded insert into the new threads,
wherein said method utilizes the kit of claim 1.

8. A threading tool for creating threads within a bore comprising:
a self-centering shaft member comprising a first end, a second end, and an outermost periphery that allows the threading tool to be inserted freely into the bore with minimal interstitial space between at least a portion of the outermost periphery of the shaft member and an inner surface of the bore;
a cutting element integrally connected to the first end and centrally located along a dissecting axis of said shaft member, said cutting element being operatively adapted to create threads within a portion of the bore; and
a coupling component proximate the second end, said coupling component being operatively adapted to connect to a mechanical power source capable of rotating said shaft member.

9. The threading tool of claim 8, wherein said cutting element comprises a threaded member having a threaded member diameter less than a largest diameter of the shaft member and greater than a diameter of the portion of the bore to be threaded.

10. The threading tool of claim 9, wherein said threading tool comprises a shoulder extending along an outer periphery of the threading tool at an intersection between said shaft member and said cutting element, said shoulder being operatively adapted to engage with a collar within the bore so as to stop said threading tool during a threading step.

11. The threading tool of claim 10, wherein said self-centering shaft member comprises an upper shaft portion having a first diameter and a lower shaft portion extending from said first end to said upper shaft portion, said lower shaft portion having a second diameter that is less than said first diameter so as to provide a shoulder extending along an outer periphery of the shaft member at an intersection between said upper shaft portion and said lower shaft portion, said shoulder being operatively adapted to engage with a collar within the bore so as to stop said threading tool during a threading step.

12. The threading tool of claim 8, wherein said self-centering shaft member comprises an upper shaft portion having a first diameter and a lower shaft portion extending from said first end to said upper shaft portion, said lower shaft portion having a second diameter that is less than said first diameter so as to provide a shoulder extending along an outer periphery of the shaft member at an intersection between said upper shaft portion and said lower shaft portion, said shoulder being operatively adapted to engage with a collar within the bore so as to stop said threading tool during a threading step.

13. The threading tool of claim 8, wherein said first diameter is substantially constant along a length of said upper shaft portion.

14. The threading tool of claim 8, wherein the bore is a spark plug bore in an engine cylinder head.

15. A kit comprising the threading tool of claim 8 and at least one of the following:
(i) an insertion tool operatively adapted to insert a threaded insert into threads formed by said threading tool, wherein said insertion tool comprises:
a self-centering insertion tool shaft member including an insertion tool first end, an insertion tool second end, and an insertion tool outermost periphery that allows the insertion tool to be inserted freely into the bore with minimal interstitial space between at least a portion of the insertion tool outermost periphery of the insertion tool shaft member and the inner surface of the bore;
an externally threaded element integrally connected to the insertion tool first end and centrally located along a dissecting axis of said insertion tool shaft member, said externally threaded element having a threaded element diameter that is less than a largest diameter of said cutting element and being operatively adapted to engage with a threaded insert; and
an insertion tool coupling component proximate the insertion tool second end, said insertion tool coupling component being operatively adapted to connect to a mechanical power source capable of rotating said insertion tool shaft member;
(ii) one or more threaded inserts having an inner diameter substantially equal to said threaded element diameter of said insertion tool and an outer diameter substantially equal to said largest diameter of said cutting element; and
(iii) a bonding agent for bonding a threaded insert with threads formed by said threading tool.

16. A method for repairing a spark plug hole within a cylinder head of an internal combustion engine, said method comprising:
without removing the cylinder head, inserting a self-centering threading tool into a spark plug bore having the spark plug hole therein;
rotating the threading tool until the threading tool stops within the spark plug bore indicating that a new set of threads has been cut into the spark plug hole;
removing the threading tool.

17. The method for repairing a spark plug hole of claim 16, further comprising:
removably mounting a threaded insert onto a distal end of a self-centering insertion tool;
inserting the self-centering insertion tool into the spark plug bore so that the distal end and threaded insert are proximate the newly threaded spark plug hole;
rotating the insertion tool until the insertion tool stops within the bore so as to engage the threaded insert with the new set of threads cut into the spark plug hole; and
removing the insertion tool leaving the threaded insert engaged in the new set of threads.

18. The method for repairing a spark plug hole within a cylinder head of an internal combustion engine of claim 17, further comprising:
applying a bonding compound to an outer surface of the threaded insert prior to said inserting step.

19. The method of claim 16 wherein the threading tool comprises:
(i) a threading tool operatively adapted to create threads within the bore, said threading tool comprising:
a self-centering threading tool shaft member including a first end, a second end, and an outermost periphery that allows the threading tool to be inserted freely into the bore with minimal interstitial space between at least a portion of the outermost periphery of the threading tool shaft member and an inner surface of the bore;
a cutting element integrally connected to the first end and centrally located along a dissecting axis of said threading tool shaft member, said cutting element being operatively adapted to create threads within a portion of the bore; and
a threading tool coupling component proximate the second end, said threading tool coupling component being operatively adapted to connect to a mechanical power source capable of rotating said threading tool shaft member

20. The method of claim 17 wherein the insertion tool comprises:
(ii) an insertion tool operatively adapted to insert the threaded insert into threads formed by said threading tool, wherein said insertion tool comprises:
a self-centering insertion tool shaft member including an insertion tool first end, an insertion tool second end, and an insertion tool outermost periphery that allows the insertion tool to be inserted freely into the bore with minimal interstitial space between at least a portion of the insertion tool outermost periphery of the insertion tool shaft member and the inner surface of the bore;
an externally threaded element integrally connected to the insertion tool first end and centrally located along a dissecting axis of said insertion tool shaft member, said externally threaded element having a threaded element diameter that is less than a largest diameter of said cutting element and being operatively adapted to engage with a threaded insert; and
an insertion tool coupling component proximate the insertion tool second end, said insertion tool coupling component being operatively adapted to connect to a mechanical power source capable of rotating said insertion tool shaft member.
